(19) United States
(12) Patent Application Publication
(10) Pub. No.: US 2016/0167060 A1
(43) Pub. Date: Jun. 16, 2016

(54) METHOD FOR RECOVERING A COPPER SULFIDE FROM AN ORE CONTAINING AN IRON SULFIDE

(71) Applicants: Gerhard ARNOLD, Ringwood, NJ (US); Ingo HAMANN, Chester, NJ (US); Alan HITCHINER, Morrinsville (NZ)

(72) Inventors: Gerhard Arnold, Ringwood, NJ (US); Ingo Hamann, Chester, NJ (US); Alan Hitchiner, Morrinsville (NZ)

(73) Assignee: Evonik Degussa GmbH, Essen (DE)

(21) Appl. No.: 14/904,698

(22) PCT Filed: Jul. 11, 2014
(86) PCT No.: PCT/EP2014/064957

§ 371 Date: Jan. 13, 2016

Related U.S. Application Data
(60) Provisional application No. 61/856,439, filed on Jul. 19, 2013.

(51) Int. Cl. B03D 1/002; B02C 23/08

(52) U.S. Cl. CPC B03D 1/002; B02C 23/08; B03D 2201/02; B03D 2203/02; B03D 2201/007

(57) ABSTRACT

In a method for recovering a copper sulfide concentrate by froth flotation from an ore containing an iron sulfide, hydrogen peroxide is added to the conditioned mineral pulp before or during flotation, a concentration of dissolved oxygen is determined in the mineral pulp after addition of hydrogen peroxide and the amount of hydrogen peroxide added is adjusted to maintain a concentration of dissolved oxygen of from 1 to 5 times a predetermined target concentration, in order to adjust the amount of hydrogen peroxide to changes in ore composition.

### FIELD OF THE INVENTION

The present invention is directed to a method of recovering a copper sulfide concentrate from an ore containing an iron sulfide which provides an improvement in concentrate grade and recovery of copper sulfides, has a low consumption of processing chemicals and can be easily adapted to changing ore compositions.

### BACKGROUND OF THE INVENTION

The most common method for recovering a copper sulfide concentrate from an ore is by froth flotation. The ore is wet ground to form a mineral pulp, which is usually conditioned with a collector compound that adsorbs to the surface of copper sulfide minerals and makes the surface of copper sulfide minerals more hydrophobic. A gas is then passed through the mineral pulp to form gas bubbles, hydrophobic particles of the mineral pulp attach predominantly to the gas/liquid phase boundary of the bubbles and are carried with the gas bubbles to the froth that forms on top of the mineral pulp. The froth is removed from the liquid surface to recover a copper sulfide concentrate.

Most copper sulfide ores contain iron sulfides in addition to copper sulfides and one aims at achieving selective flotation of copper sulfides, with iron sulfides remaining in the flotation tailings.

U.S. Pat. No. 5,110,455 discloses a method for separating copper sulfide from rimmed iron sulfide which uses conditioning of the mineral pulp with an oxidant that is preferably hydrogen peroxide. The document teaches to add an oxidant in an amount that raises the redox potential of the mineral pulp by 20 to 500 mV.

A Uribe-Salas et al., Int. J. Miner. Process. 59 (2000) 69-83 describe an improvement in the selectivity for the flotation of chalcopyrite from an ore of pyrite matrix by raising the redox potential of the mineral pulp by 0.1 V through an addition of hydrogen peroxide before flotation. The amount of hydrogen peroxide added is adjusted to provide a constant redox potential.

### SUMMARY OF THE INVENTION

The inventors of the present invention have found that a substantial improvement in concentrate grade and recovery of copper sulfides can be achieved by addition of small amounts of hydrogen peroxide to the conditioned mineral pulp before or during flotation. Addition of such small amounts of hydrogen peroxide does not lead to an increase in the redox potential of the pulp, as taught in the prior art, but to a decreased redox potential. The inventors have also observed that the optimum amount of hydrogen peroxide for such a process does not correspond to a particular value of the redox potential in the mineral pulp and that the curve of the redox potential plotted against the amount of hydrogen peroxide may display several maxima and minima for hydrogen peroxide amounts below and up to the optimum amount. Therefore, the redox potential of the mineral pulp cannot be used to adjust the amount of hydrogen peroxide to the optimum value when changes in the ore composition occur. The inventors of the present invention have further found that the optimum amount of hydrogen peroxide to be used can be determined based on the concentration of dissolved oxygen in the mineral pulp after addition of hydrogen peroxide and that an optimum recovery of copper sulfides can be maintained by adjusting the amount of hydrogen peroxide to maintain a predetermined concentration of dissolved oxygen. This allows adapting the method to changes in the ore composition without carrying out ore assays or extra optimization experiments.

The present invention is therefore directed to a method for recovering a copper sulfide from an ore containing an iron sulfide, comprising the steps of
a) wet grinding the ore with grinding media to form a mineral pulp,
b) conditioning the mineral pulp with a collector compound to form a conditioned mineral pulp, and
c) froth flotation of the conditioned mineral pulp to form a froth and a flotation tailing, separating the froth from the flotation tailing to recover a copper sulfide concentrate,

wherein hydrogen peroxide is added to the conditioned mineral pulp between steps b) and c) or during step c), a concentration of dissolved oxygen is determined in the mineral pulp after addition of hydrogen peroxide and the amount of hydrogen peroxide added is adjusted to maintain a concentration of dissolved oxygen of from 1 to 5 times a predetermined target concentration.

### BRIEF DESCRIPTION OF THE DRAWINGS

FIG. 1 shows redox potential Eₕ plotted against the amount of added hydrogen peroxide for the experiments of example 1.

FIG. 2 shows DO plotted against the logarithm of the amount of hydrogen peroxide added in the experiments of example 1.

FIG. 3 shows curves for cumulated copper concentrate grade (y-axis) plotted against cumulated copper recovery (x-axis) for examples 2 and 3.

FIG. 4 shows redox potential Eₕ plotted against the amount of added hydrogen peroxide for the experiments of example 4.

FIG. 5 shows DO plotted against the logarithm of the amount of hydrogen peroxide added in the experiments of example 4.

FIG. 6 shows curves for cumulated copper concentrate grade (y-axis) plotted against cumulated copper recovery (x-axis) for examples 5 to 7.

FIG. 7 shows redox potential Eₕ plotted against the amount of added hydrogen peroxide for the experiments of example 8.

FIG. 8 shows DO plotted against the logarithm of the amount of hydrogen peroxide added in the experiments of example 8.

FIG. 9 shows curves for cumulated copper concentrate grade (y-axis) plotted against cumulated copper recovery (x-axis) for examples 9 and 10.

FIG. 10 shows redox potential Eₕ plotted against the amount of added hydrogen peroxide for the experiments of example 11.

FIG. 11 shows DO plotted against the logarithm of the amount of hydrogen peroxide added in the experiments of example 11.

FIG. 12 shows curves for cumulated copper concentrate grade (y-axis) plotted against cumulated copper recovery (x-axis) for examples 12 and 13.

### DETAILED DESCRIPTION OF THE INVENTION

The method of the invention recovers a copper sulfide concentrate from an ore containing an iron sulfide using three method steps.

In the first step of the method of the invention, the ore is ground with grinding media to form a mineral pulp, i.e. an aqueous suspension of ground ore. Suitable grinding media for grinding ores are known from the prior art. In a preferred embodiment, the grinding media comprise a grinding surface made of steel or cast iron having an iron content of at least 90% by weight. Grinding can be carried out in any mill known from the art that uses grinding media. Suitable mills are ball mills using balls as grinding media or rod mills using rods as grinding media, with ball mills being preferred. The mill preferably has a lining of an abrasion resistant material.

The ore is wet milled to form a mineral pulp, i.e. an aqueous suspension of ground ore. The ore may be fed to the mill together with water. Alternatively, ore and water are fed separately. Milling is carried out typically to a median particle size of 50-200 μm. Preferably, the ore is ground to what is called the liberation size, i.e. the maximum median particle size where essentially all copper sulfide is exposed to the particle surface and essentially no copper sulfide remains encapsulated inside a particle.

In the second step of the method of the invention, the ore is conditioned with a collector compound to form a conditioned mineral pulp. Collector compounds are compounds which after addition to the mineral pulp adsorb to the surface of copper sulfides and render the surface hydrophobic. Collector compounds suitable for froth flotation of copper sulfides are known from the prior art. Preferably, an alkali metal alkyl xanthate is used as collector, such as potassium amyl xanthate or sodium ethyl xanthate. Conditioning is typically carried out by adding the conditioner to the mineral pulp and mixing for a time period sufficient to achieve adsorption of the conditioner to the mineral surface, typically for less than 15 minutes. Preferably for 0.5 to 15 minutes. Alternatively, the collector is added in the first step of grinding and conditioning is carried out by retaining the mineral pulp for a corresponding time.

Further reagents, such as frothers, pH regulators, depressants and mixtures thereof may be added in the grinding step, the conditioning step or in both steps. Frothers are compounds that stabilize the froth formed in a froth flotation. Suitable frothers are commercially available, e.g. from Huntsman under the trade name Polyfroth®. Depressants are compounds that render the surface of unwanted minerals more hydrophilic. Polyamines known from the prior art, such as diethylenetriamine or triethylenetetraamine, may be used as depressants for iron sulfides. pH regulators, such as calcium oxide, calcium hydroxide or sodium carbonate, may be added to adjust the pH of the mineral pulp to a desired value, preferably to a value in the range from 7 to 11.

In the third step of the method of the invention, the conditioned mineral pulp is subjected to froth flotation to form froth and a flotation tailing, with hydrogen peroxide being added to the conditioned mineral pulp during froth flotation or between the second step of conditioning the mineral pulp and the step of froth flotation. The froth is separated from the flotation tailing to recover a copper sulfide concentrate. Froth flotation may be carried out using equipment and procedures known to a person skilled in the art for the froth flotation of copper ores.

Froth flotation may be carried out as a single stage flotation or as a multiple stage flotation, using e.g. rougher, scavenger and cleaner stages. In a multiple stage froth flotation, hydrogen peroxide is preferably added before the first flotation stage or during the first flotation stage.

When hydrogen peroxide is added between the step of conditioning the mineral pulp and the step of froth flotation, the time period between addition of hydrogen peroxide and froth flotation is preferably less than 15 min, more preferably less than 3 min and most preferably less than 1 min. Limiting the time period between addition of hydrogen peroxide and froth flotation improves both concentrate grade and recovery of copper sulfides.

In a preferred embodiment of the method of the invention, froth flotation is carried out continuously and hydrogen peroxide is added continuously during froth flotation.

Hydrogen peroxide is preferably added as an aqueous solution comprising 0.5 to 5% by weight hydrogen peroxide. Adding such a dilute hydrogen peroxide solution provides better concentrate grade and recovery than obtained with the same amount of a more concentrated hydrogen peroxide solution. Therefore, it is preferred to dilute a commercial hydrogen peroxide solution comprising 30 to 70% by weight hydrogen peroxide to a dilute solution comprising 0.5 to 5% by weight hydrogen peroxide before adding it in the method of the invention.

The amount of hydrogen peroxide added to the conditioned pulp can be varied over a wide range depending on the ore composition. The method of the invention requires only small amounts of hydrogen peroxide. In general, less than 100 g hydrogen peroxide per ton of ore are needed and preferably less than 50 g/t are used. The method can be carried out with as little as 2 g/t hydrogen peroxide per ton of ore and preferably at least 5 g/t are used.

Usually there will be an optimum amount of hydrogen peroxide per ton of ore that depends on the ore composition. Increasing the amount of added hydrogen peroxide up to the optimum amount will lead to an increase in concentrate grade and recovery of copper sulfides, whereas increasing the amount of added hydrogen peroxide beyond the optimum amount will not lead to any further improvement, but in general will even lead to a reduced concentrate grade and recovery of copper sulfides. The optimum amount of hydrogen peroxide corresponds to a particular concentration of dissolved oxygen in the mineral pulp after addition of hydrogen peroxide, which concentration depends on the type of ore. Small variations in the ore composition of a particular ore type, which occur within an ore deposit, will require to adjust the amount of hydrogen peroxide added but will in general not affect the particular value for the concentration of dissolved oxygen that corresponds to an optimum amount of hydrogen peroxide. Therefore, in the method of the present invention a concentration of dissolved oxygen is determined in the mineral pulp after addition of hydrogen peroxide and the amount of hydrogen peroxide added is adjusted to maintain a concentration of dissolved oxygen of from 1 to 5 times a predetermined target concentration. Preferably, the amount of hydrogen peroxide added is adjusted to maintain a concentration of dissolved oxygen of from 1 to 2 times a predetermined target concentration. Such adjusting can be done either regularly or when a change in ore composition has occurred.

The concentration of dissolved oxygen in the mineral pulp can be determined with equipment known from the prior art.

Preferred sensors for determining the concentration of dissolved oxygen are amperometric sensors or optical sensors that measure oxygen concentration by electrochemical reduction of oxygen or by oxygen caused fluorescence quenching of a dye. The sensor preferably has an oxygen permeable membrane on the oxygen sensing device, which membrane has low permeability for hydrogen peroxide.

The predetermined target concentration of dissolved oxygen to be used in the method of the invention can be determined by carrying out a series of flotation experiments varying the amount of hydrogen peroxide added, measuring the concentration of dissolved oxygen in the mineral pulp after addition of hydrogen peroxide, analyzing the copper sulfide concentrate recovered, selecting the critical concentration of dissolved oxygen for which an optimum in concentrate grade and recovery of copper sulfides is achieved and selecting the target concentration as 1.1 to 2 times the critical concentration.

In a preferred embodiment of the method of the invention, the target concentration of dissolved oxygen is determined in a series of preliminary experiments in which the amount of added hydrogen peroxide is varied, the concentration of dissolved oxygen is determined in the mineral pulp after addition of hydrogen peroxide, the concentration of dissolved oxygen is plotted over the amount of added hydrogen peroxide to give a curve having an inflection point, a critical concentration of dissolved oxygen is determined as the concentration of dissolved oxygen at the inflection point, and the target concentration is selected as 1.1 to 2 times the critical concentration. Preferably, the concentration of dissolved oxygen is plotted against the logarithm of the amount of added hydrogen peroxide to give a curve having an essentially constant slope on both sides of the inflection point. This embodiment allows selecting a target concentration of dissolved oxygen without carrying out ore assays or extra optimization experiments.

When grinding media are used which comprise a grinding surface made of steel or cast iron having an iron content of at least 90% by weight, the curve of the concentration of dissolved oxygen plotted against the logarithm of the amount of added hydrogen peroxide is usually flat or has a small slope for hydrogen peroxide amounts below the inflection point and has a larger positive slope for hydrogen peroxide amounts above the inflection point. For such grinding media, the target concentration of dissolved oxygen is preferably selected at a value larger than any of the concentrations of dissolved oxygen measured for hydrogen peroxide amounts below the inflection point, in order to ensure stable operation of the method and to avoid dosing too small amounts of hydrogen peroxide.

The method of the invention provides a substantial increase in the concentrate grade and recovery of copper sulfides in a flotation process for recovering a copper sulfide from an ore containing an iron sulfide by adding small amounts of hydrogen peroxide to the conditioned mineral pulp before or during flotation and provides a simple way for adjusting the required amount of hydrogen peroxide to changes in ore composition that does not require ore assays or extra optimization experiments.

The following examples illustrate the invention, but are not intended to limit the scope of the invention.

### EXAMPLES

In all flotation experiments, ores were ground to a particle size P₈₀ of 200 μm with a laboratory Magotteaux Mill® using 16*1 inch forged carbon steel rods as grinding media. The resulting mineral pulp was transferred to a laboratory flotation cell and mixed for two minutes to homogenize. Sodium ethyl xanthate was added as collector at 21 g per ton of ore, followed by 5 g per ton of POLYFROTH® H27 frother from Huntsman. The resulting mineral pulp was conditioned for 1 min before flotation was started by introducing air. Four timed concentrates were collected during flotation over intervals given in the examples. Each concentrate was collected by hand scraping the froth from the surface of the pulp once every 10 seconds. Concentrates were weighed and assayed and cumulated grades and recoveries were calculated from these data. Grades were plotted against recovery and the values for grades at a specific copper recovery and recoveries at a specific copper grade given in the tables below were read from these curves.

### Examples 1 to 3

Flotation was carried out with a sedimentary copper/gold ore having a head assay of 1.74% Cu, 9.95% Fe, 3.27 ppm Au, 168 ppm Bi, and 3.21% S.

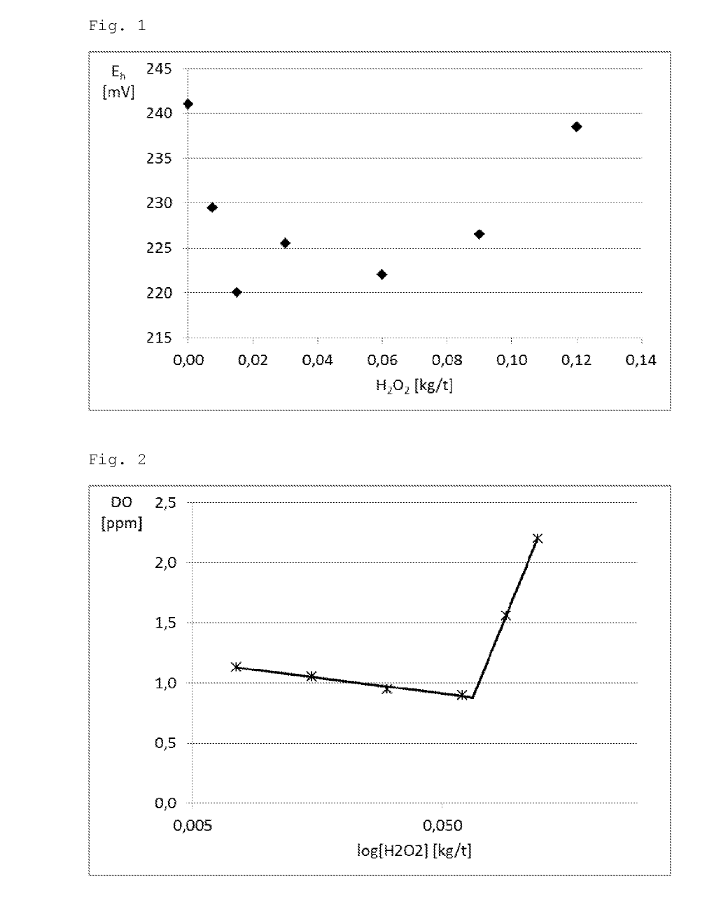

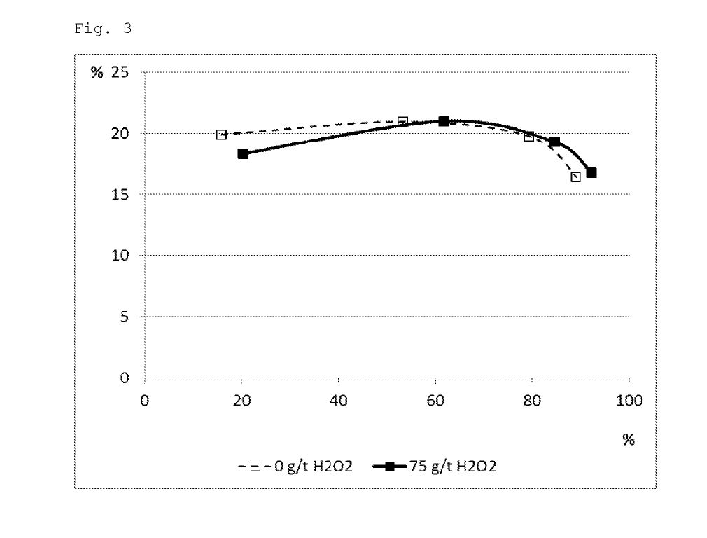

In example 1, varying amounts of hydrogen peroxide were added immediately before starting flotation and the redox potential (Eₕ) and the content of dissolved oxygen (DO) were determined immediately after flotation was started. The results are summarized in table 1. FIG. 1 shows the values of Eₕ plotted against the amount of added hydrogen peroxide. FIG. 2 shows a curve of DO plotted against the logarithm of the amount of added hydrogen peroxide. The curve of FIG. 2 shows an inflection point for a hydrogen peroxide amount of about 66 g/t, with DO slightly decreasing upon addition of smaller amounts and DO rapidly increasing upon addition of larger amounts. The Eₕ values of FIG. 1 appear to have at least two minima and one maximum for Eₕ for small amounts of hydrogen peroxide added. The same Eₕ as observed for an optimum amount of hydrogen peroxide can also be observed for much smaller amounts of hydrogen peroxide, making Eₕ unsuitable for adjusting the amount of hydrogen peroxide after changes in ore composition.

TABLE 1
Variation of added hydrogen peroxide amount

| | |
|---|---|
| H₂O₂ added | Example 1 |

| [g/t] | DO [ppm] | Eh [mV] |
|---|---|---|
| 0 | 1.13 | 241 |
| 7.5 | 1.13 | 230 |
| 15 | 1.05 | 220 |
| 30 | 0.95 | 226 |
| 60 | 0.90 | 222 |
| 90 | 1.56 | 227 |
| 120 | 2.20 | 239 |

In examples 2 and 3, flotation was carried out with concentrates collected over intervals of 0.5, 2, 5, and 10 minutes. No hydrogen peroxide was added in example 2. In example 3, a 1% by weight aqueous hydrogen peroxide solution was added in an amount of 75 g/t ore immediately before starting flotation.

FIG. 3 shows the curves for cumulated copper concentrate grade plotted against cumulated copper recovery for examples 2 and 3. Tables 2 and 3 compare these results at 85% copper recovery and at 18% concentrate copper grade.

TABLE 2
Copper and gold concentrate grades and gold
and diluent recoveries at 85% copper recovery

| | | Grade | | Recovery | | | |
|---|---|---|---|---|---|---|---|
| | | Cu | Au | Au | Bi | IS | NSG |
| Example | H₂O₂ added | [%] | [ppm] | [%] | [%] | [%] | [%] |
| 2* | 0 g/t | 18.2 | 25.0 | 62.5 | 69.2 | 18.8 | 3.6 |
| 3 | 75 g/t | 19.2 | 26.0 | 55.0 | 65.0 | 13.6 | 3.4 |

*Not according to the invention,
IS = iron sulfides,
NSG = non sulfide gangue

TABLE 3
Copper and gold recovery and concentrate gold and
diluents grade at 18% concentrate copper grade

| | | Recovery | | Grade | | | |
|---|---|---|---|---|---|---|---|
| | | Cu | Au | Au | Bi | IS | NSG |
| Example | H₂O₂ added | [%] | [%] | [ppm] | [ppm] | [%] | [%] |
| 2* | 0 g/t | 85.7 | 58.8 | 24.7 | 1420 | 6.2 | 41.5 |
| 3 | 75 g/t | 89.3 | 63.3 | 24.7 | 1310 | 4.7 | 42.8 |

*Not according to the invention,
IS = iron sulfides,
NSG = non sulfide gangue

### Examples 4 to 7

Flotation was carried out with a volcanogenic sulfide deposit ore having a head assay of 2.63% Cu, 19.2% Fe, and 15.9% S.

In example 4, varying amounts of hydrogen peroxide were added immediately before starting flotation and the redox potential (Eₕ) and the content of dissolved oxygen (DO) were determined immediately after flotation was started. The results are summarized in table 4.

TABLE 4
Variation of added hydrogen peroxide amount

| | |
|---|---|
| H₂O₂ added | Example 4 |

| [g/t] | DO [ppm] | Eh [mV] |
|---|---|---|
| 0 | 0.74 | 250 |
| 30 | 0.77 | 243 |
| 60 | 0.75 | 237 |
| 120 | 0.74 | 239 |
| 180 | 0.72 | 235 |
| 240 | 1.05 | 236 |
| 300 | 1.49 | 240 |
| 360 | 1.67 | 245 |

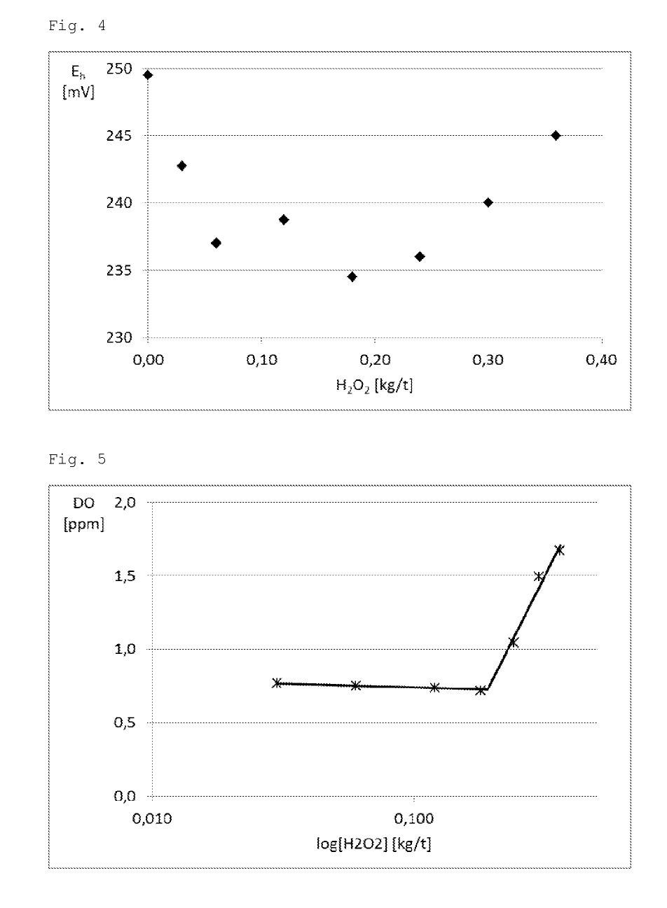

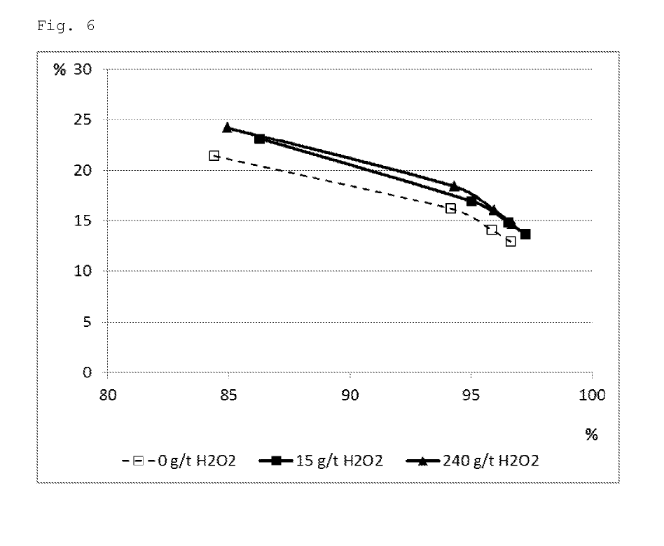

FIG. 4 shows the values of Eₕ plotted against the amount of added hydrogen peroxide. FIG. 5 shows a curve of DO plotted against the logarithm of the amount of added hydrogen peroxide. The curve of FIG. 5 shows an inflection point for a hydrogen peroxide amount of about 190 g/t, with no significant change of DO upon addition of smaller amounts and DO rapidly increasing upon addition of larger amounts. The Eₕ values of FIG. 4 appear to have at least two minima and one maximum for Eₕ for small amounts of hydrogen peroxide added.

In examples 5 to 7, flotation was carried out with concentrates collected over intervals of 0.5, 2, 4, and 7 minutes. No hydrogen peroxide was added in example 5. In examples 6 and 7, a 1% by weight aqueous hydrogen peroxide solution was added in amounts of 15 g/t ore and 240 g/t ore immediately before starting flotation.

FIG. 6 shows the curves for cumulated copper concentrate grade plotted against cumulated copper recovery for examples 5 to 7. Tables 5 and 6 compare these results at 90% copper recovery and at 18% concentrate copper grade.

TABLE 5
Copper and iron concentrate grades and
diluent recoveries at 90% copper recovery

| | | Grade | | Recovery | | |
|---|---|---|---|---|---|---|
| | | Cu | Fe | Fe | IS | NSG |
| Example | H₂O₂ added | [%] | [%] | [%] | [%] | [%] |
| 5* | 0 g/t | 15.5 | 26.8 | 18.2 | 10.0 | 4.5 |
| 6 | 15 g/t | 20.5 | 28.8 | 17.7 | 7.7 | 4.1 |
| 7 | 240 g/t | 21.1 | 27.6 | 16.4 | 8.0 | 3.9 |

*Not according to the invention,
IS = iron sulfides,
NSG = non sulfide gangue

TABLE 6
Copper and iron recovery and concentrate diluents
grade at 18% concentrate copper grade

| | | Recovery | | Grade | | |
|---|---|---|---|---|---|---|
| | | Cu | Fe | Fe | IS | NSG |
| Example | H₂O₂ added | [%] | [%] | [%] | [%] | [%] |
| 5* | 0 g/t | 91.0 | 18.8 | 26.8 | 19.0 | 28.4 |
| 6 | 15 g/t | 93.5 | 20.2 | 28.1 | 18.0 | 26.4 |
| 7 | 240 g/t | 94.6 | 19.5 | 26.9 | 20.0 | 27.5 |

*Not according to the invention,
IS = iron sulfides,
NSG = non sulfide gangue

### Examples 8 to 10

Flotation was carried out with a porphyry copper/gold ore having a head assay of 0.43% Cu, 5.4% Fe, 0.18 ppm Au and 5.0% S.

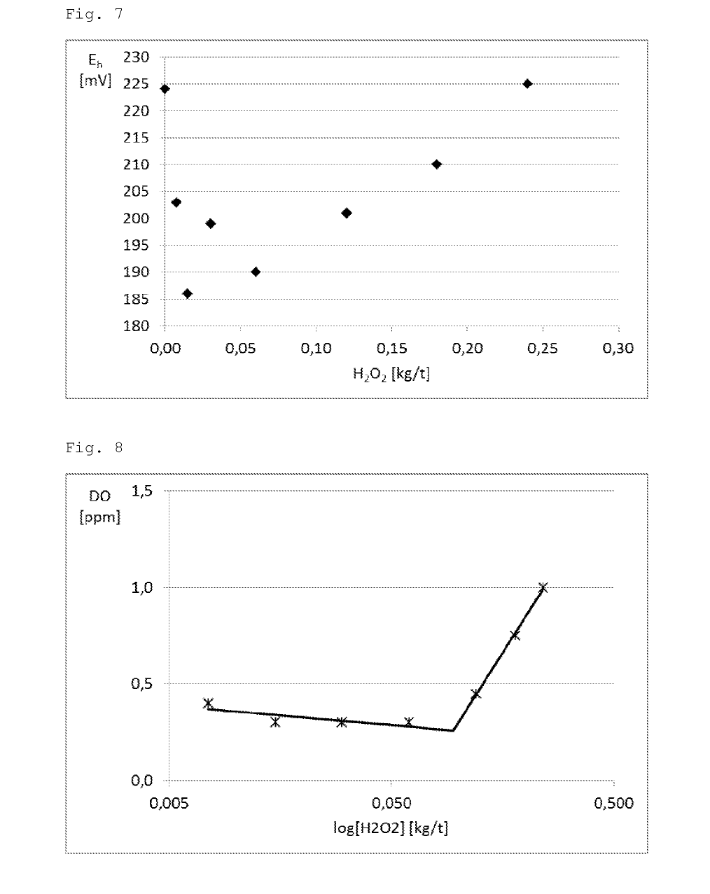

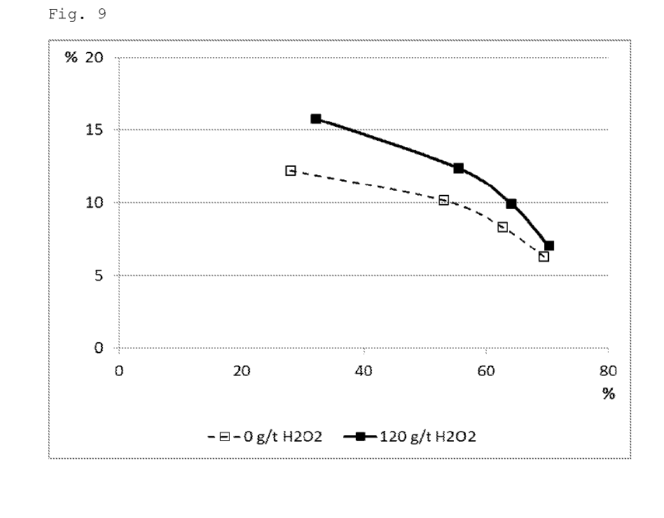

In example 8, varying amounts of hydrogen peroxide were added immediately before starting flotation and the redox potential (Eₕ) and the content of dissolved oxygen (DO) were determined immediately after flotation was started. The results are summarized in table 7. FIG. 7 shows the values of Eₕ plotted against the amount of added hydrogen peroxide. FIG. 8 shows a curve of DO plotted against the logarithm of the amount of added hydrogen peroxide. The curve of FIG. 8 shows an inflection point for a hydrogen peroxide amount of about 95 g/t, with no significant change of DO upon addition of smaller amounts and DO rapidly increasing upon addition of larger amounts. The Eₕ values of FIG. 7 appear to have at least two minima and one maximum for Eₕ for small amounts of hydrogen peroxide added. The same Eₕ as observed for an optimum amount of hydrogen peroxide can also be observed for much smaller amounts of hydrogen peroxide, making Eₕ unsuitable for adjusting the amount of hydrogen peroxide after changes in ore composition.

TABLE 7
Variation of added hydrogen peroxide amount

| | |
|---|---|
| H₂O₂ added | Example 8 |

| [g/t] | DO [ppm] | Eh [mV] |
|---|---|---|
| 0 | 0.40 | 224 |
| 7.5 | 0.40 | 203 |
| 15 | 0.30 | 186 |
| 30 | 0.30 | 199 |
| 60 | 0.30 | 190 |
| 120 | 0.45 | 201 |
| 180 | 0.75 | 210 |
| 240 | 1.00 | 225 |

In examples 9 and 10, flotation was carried out with concentrates collected over intervals of 0.5, 2, 4, and 9 minutes. No hydrogen peroxide was added in example 9. In example 10, a 1% by weight aqueous hydrogen peroxide solution was added in an amount of 120 g/t ore immediately before starting flotation.

FIG. 9 shows the curves for cumulated copper concentrate grade plotted against cumulated copper recovery for examples 9 and 10. Tables 8 and 9 compare these results at 70% copper recovery and at 9% concentrate copper grade.

TABLE 8
Copper and gold concentrate grades and gold
and diluent recoveries at 70% copper recovery

| | | Grade | | Recovery | | |
|---|---|---|---|---|---|---|
| | | Cu | Au | Au | IS | NSG |
| Example | H₂O₂ added | [%] | [ppm] | [%] | [%] | [%] |
| 9* | 0 g/t | 6.2 | 1.3 | 35.0 | 14.5 | 3.1 |
| 10 | 120 g/t | 7.2 | 1.7 | 46.0 | 11.2 | 2.6 |

*Not according to the invention,
IS = iron sulfides,
NSG = non sulfide gangue

TABLE 9
Copper and gold recovery and concentrate gold and
diluents grade at 9% concentrate copper grade

| | | Recovery | | Grade | | |
|---|---|---|---|---|---|---|
| | | Cu | Au | Au | IS | NSG |
| Example | H₂O₂ added | [%] | [%] | [ppm] | [%] | [%] |
| 9* | 0 g/t | 60.0 | 27.5 | 1.7 | 33.0 | 41.0 |
| 10 | 120 g/t | 67.0 | 42.5 | 2.0 | 27.0 | 47.0 |

*Not according to the invention,
IS = iron sulfides,
NSG = non sulfide gangue

Table 9 shows an additional improvement in the recovery of copper and gold.

### Examples 11 to 13

Flotation was carried out with an iron oxide hosted copper/gold ore having a head assay of 0.83% Cu, 21.7% Fe, 0.39 ppm Au, 568 ppm As, and 4.0% S.

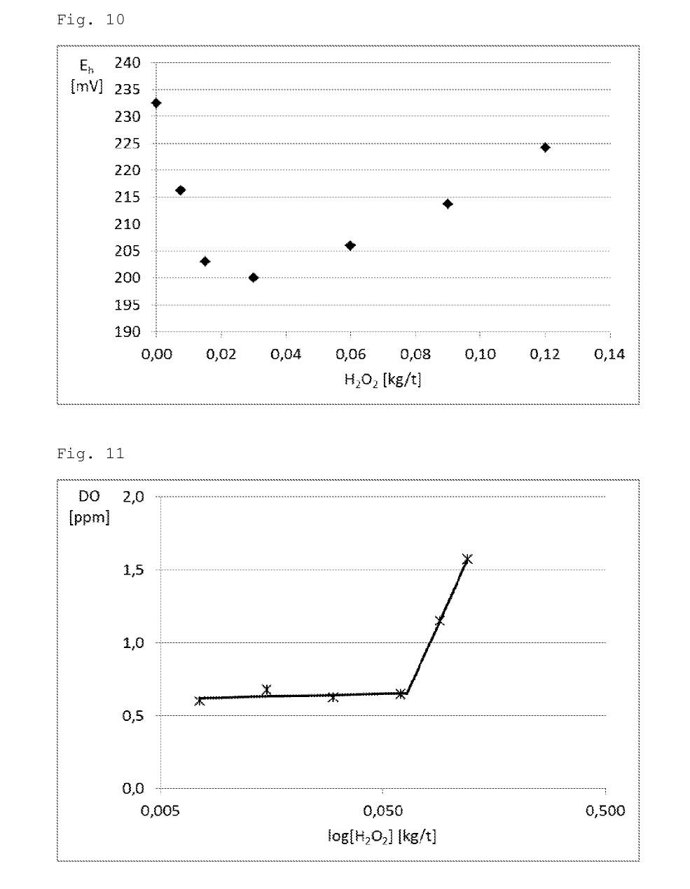

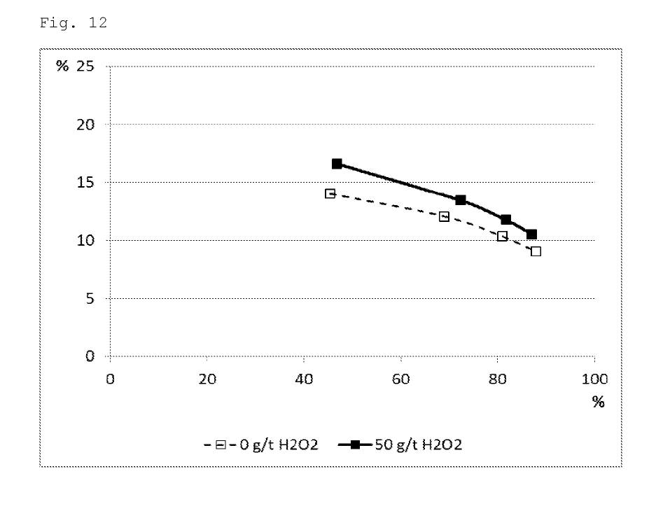

In example 11, varying amounts of hydrogen peroxide were added immediately before starting flotation and the redox potential (Eₕ) and the content of dissolved oxygen (DO) were determined immediately after flotation was started. The results are summarized in table 10. FIG. 10 shows the values of Eₕ plotted against the amount of added hydrogen peroxide. FIG. 11 shows a curve of DO plotted against the logarithm of the amount of added hydrogen peroxide. The curve of FIG. 11 shows an inflection point for a hydrogen peroxide amount of about 64 g/t, with no significant change of DO upon addition of smaller amounts and DO rapidly increasing upon addition of larger amounts. The Eₕ values of FIG. 10 appear to have a minimum for Eₕ for small amounts of hydrogen peroxide added. The same Eₕ as observed for an optimum amount of hydrogen peroxide can also be observed for a much smaller amount of hydrogen peroxide, making Eₕ unsuitable for adjusting the amount of hydrogen peroxide after changes in ore composition.

TABLE 10
Variation of added hydrogen peroxide amount

| | |
|---|---|
| H₂O₂ added | Example 11 |

| [g/t] | DO [ppm] | Eh [mV] |
|---|---|---|
| 0 | 0.55 | 233 |
| 7.5 | 0.60 | 216 |
| 15 | 0.68 | 203 |
| 30 | 0.63 | 200 |
| 60 | 0.65 | 206 |
| 90 | 1.15 | 214 |
| 120 | 1.57 | 224 |

In examples 12 and 13, flotation was carried out with concentrates collected over intervals of 0.5, 2, 4, and 8 minutes. No hydrogen peroxide was added in example 12. In example 13 a 1% by weight aqueous hydrogen peroxide solution was added in an amount of 50 g/t ore immediately before starting flotation.

FIG. 12 shows the curves for cumulated copper concentrate grade plotted against cumulated copper recovery for examples 12 and 13. Tables 11 and 12 compare these results at 80% copper recovery and at 13% concentrate copper grade.

TABLE 11
Copper and gold concentrate grades and gold
and diluent recoveries at 80% copper recovery

| | | Grade | | Recovery | | | |
|---|---|---|---|---|---|---|---|
| | | Cu | Au | Au | As | IS | NSG |
| Example | H₂O₂ added | [%] | [ppm] | [%] | [%] | [%] | [%] |
| 12* | 0 g/t | 10.5 | 3.7 | 60.0 | 33.9 | 46.3 | 1.8 |
| 13 | 50 g/t | 12.0 | 3.9 | 59.0 | 27.5 | 38.0 | 1.4 |

*Not according to the invention,
IS = iron sulfides,
NSG = non sulfide gangue

TABLE 12
Copper and gold recovery and concentrate gold and
diluents grade at 13% concentrate copper grade

| | | Recovery | | Grade | | | |
|---|---|---|---|---|---|---|---|
| | | Cu | Au | Au | As | IS | NSG |
| Example | H₂O₂ added | [%] | [%] | [ppm] | [ppm] | [%] | [%] |
| 12* | 0 g/t | 57.5 | 36.0 | 3.8 | 2740 | 42.8 | 19.1 |
| 13 | 50 g/t | 75.0 | 53.0 | 4.0 | 2780 | 41.8 | 20.1 |

*Not according to the invention,
IS = iron sulfides,
NSG = non sulfide gangue

1. A method for recovering a copper sulfide from an ore containing an iron sulfide, comprising the steps of:
a) wet grinding the ore with grinding media to form a mineral pulp,
b) conditioning the mineral pulp with a collector compound to form a conditioned mineral pulp, and
c) froth flotation of the conditioned mineral pulp to form a froth and a flotation tailing, separating the froth from the flotation tailing to recover a copper sulfide concentrate,
wherein hydrogen peroxide is added to the conditioned mineral pulp between steps b) and c) or during step c), a concentration of dissolved oxygen is determined in the mineral pulp after addition of hydrogen peroxide and the amount of hydrogen peroxide added is adjusted to maintain a concentration of dissolved oxygen of from 1 to 5 times a predetermined target concentration.

2. The method of claim 1, wherein the target concentration of dissolved oxygen is determined in a series of preliminary experiments in which the amount of added hydrogen peroxide is varied, the concentration of dissolved oxygen is determined in the mineral pulp after addition of hydrogen peroxide, the concentration of dissolved oxygen is plotted over the amount of added hydrogen peroxide to give a curve having an inflection point, a critical concentration of dissolved oxygen is determined as the concentration of dissolved oxygen at the inflection point, and the target concentration is selected as 1.1 to 2 times the critical concentration.

3. The method of claim 1, wherein the hydrogen peroxide is added less than 15 minutes before a gas is introduced for froth flotation.

4. The method of claim 1, wherein froth flotation is carried out continuously and hydrogen peroxide is added continuously during froth flotation.

5. The method of claim 1, wherein hydrogen peroxide is added as an aqueous solution comprising 0.5 to 5% by weight hydrogen peroxide.

6. The method of claim 1, wherein an alkali metal alkyl xanthate is used as collector.

7. The method of claim 1, wherein the grinding media comprise a grinding surface made of steel having an iron content of at least 90% by weight.

8. The method of claim 2 wherein the hydrogen peroxide is added less than 15 minutes before a gas is introduced for froth flotation.

9. The method of claim 2, wherein froth flotation is carried out continuously and hydrogen peroxide is added continuously during froth flotation.

10. The method of claim 2, wherein hydrogen peroxide is added as an aqueous solution comprising 0.5 to 5% by weight hydrogen peroxide.

11. The method of claim 3, wherein hydrogen peroxide is added as an aqueous solution comprising 0.5 to 5% by weight hydrogen peroxide.

12. The method of claim 4, wherein hydrogen peroxide is added as an aqueous solution comprising 0.5 to 5% by weight hydrogen peroxide.

13. The method of claim 2, wherein an alkali metal alkyl xanthate is used as collector.

14. The method of claim 3, wherein an alkali metal alkyl xanthate is used as collector.

15. The method of claim 4, wherein an alkali metal alkyl xanthate is used as collector.

16. The method of claim 5, wherein an alkali metal alkyl xanthate is used as collector.

17. The method of claim 2, wherein the grinding media comprise a grinding surface made of steel having an iron content of at least 90% by weight.

18. The method of claim 3, wherein the grinding media comprise a grinding surface made of steel having an iron content of at least 90% by weight.

19. The method of claim 4, wherein the grinding media comprise a grinding surface made of steel having an iron content of at least 90% by weight.

20. The method of claim 5, wherein the grinding media comprise a grinding surface made of steel having an iron content of at least 90% by weight.
